(19) United States
(12) Patent Application Publication
(10) Pub. No.: US 2002/0022472 A1
(43) Pub. Date: Feb. 21, 2002

(54) Multiple virtual wallets in wireless device

(75) Inventors: Theodore Watler, Long Beach, CA (US); Jerry Hanley, Santa Monica, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Telemac Corporation, Los Angeles, CA

(21) Appl. No.: 09/915,203

(22) Filed: Jul. 23, 2001

Related U.S. Application Data
(60) Provisional application No. 60/220,241, filed on Jul. 21, 2000.

(51) Int. Cl. H04M 11/00

(52) U.S. Cl. 455/405; 455/408

(57) ABSTRACT

A system having a wireless device capable of monitoring and tracking its own usage and account activities is disclosed. The wireless device includes an account management application and accounting applications. The account management application manages a variety of accounts in conjunction with the accounting applications and is used by a user to determine how each call/transaction is to be paid for. For example, the user of the wireless device may wish to pay for business calls using a first account and personal calls using a second account.

### CROSS-REFERENCES TO RELATED APPLICATION

This application claims the benefit of priority under 35 U.S.C. §119 from U.S. Provisional Patent Application Ser. No. 60/220,241 filed on Jul. 21, 2000, the disclosure of which is hereby incorporated by reference in its entirety for all purposes.

### BACKGROUND OF THE INVENTION

The present invention generally relates to a system with an account management protocol for wireless devices, and in particular, to a system with an account management protocol which is used to monitor and track usage and account activities of a wireless device.

More specifically, the account management system is adapted for a mobile phone so as to allow the usage and account activities of the mobile phone to be tracked and monitored on an individual basis. A number of accounting systems are described in U.S. Pat. No. 5,325,418 (the '418 patent), U.S. Pat. No. 5,625,669 (the '669 patent), U.S. Pat. No. 5,577,100 (the '100 patent), and U.S. Pat. No. 6,198,915 B1 (the '915 patent), which are incorporated herein by reference. The '418 and '669 patents describe accounting systems with features that have particular application to post-paid mobile phone services, such as a mobile phone rental service or controlled mobile phone services. In a controlled mobile phone service, capturing phone call data and calculating phone charges for each call enable service providers (or corporations in an intra-corporate system) to limit, or at least monitor, mobile phone usage before the periodic billing cycle. For example, if mobile phone usage exceeds a pre-established limit, the mobile phone could be temporarily disabled or restricted until an interim payment or additional credit sources are obtained. In an intra-corporate system, a warning message could be sent to a corporate authority that could then either authorize additional use or temporarily disable the mobile phone. In such systems, phone call data is stored in the mobile phone and then transmitted to a host processor that calculates charges. The host processor is typically located on a network that is separate from the mobile phone.

Since the issuance of the '418 and '669 patents, the state of the art has advanced to a point where an accounting application in the mobile phone is able to calculate calling charges internally. As described in the '100 and '915 patents, such systems minimize the communication traffic required between the service provider's host processor and the mobile phone and thus expand the overall traffic handling capacity of the mobile phone system. The '100 and '915 patents describe accounting systems with features that have particular application to pre-paid mobile phone services.

Due to the increasing ease of use and lower costs, the proliferation and use of mobile phones is going to continue. Many companies nowadays provide employees with mobile phones in order to ensure that such employees remain in contact. Since carrying two mobile phones is quite impractical, these employees inevitably tend to use their company-provided mobile phones for both business and personal calls. Hence, in order to prevent abuses and/or provide accurate accounting, it would be desirable to have the ability to monitor proper usage and account activities of company-provided mobile phones.

Furthermore, some mobile phones on the market today provide a two-line or multi-line capability. With a two-line phone, the two phone lines could be dedicated to handle a first type and a second type of calls respectively. As a result, account activities for different types of calls may need to be monitored separately. Therefore, it would be desirable to provide a mobile phone system that is capable of handling and monitoring different types of usage and account activities for wireless devices.

### SUMMARY OF THE INVENTION

The system of the present invention relates to wireless communication systems having wireless devices, particularly mobile phones, that are part of a wireless communication network. In particular, the present invention relates to a wireless device, such as a mobile phone, that includes an internal account management application for internal management of a variety of accounts. In an exemplary embodiment, the account management application interacts with an accounting application for calculation of communication charges on the fly. Such mobile phones are typically cellular telephones in a cellular phone network, radio telephones in a personal communication service network or other communication system, where the mobile phone is moveable from place to place.

Use of the system of the present invention is intended for mobile phones, where real time calculation of calling charges is desirable to limit phone usage or to immediately bill for phone usage where the billings of the public switched service providers and participating wireless service providers are not yet available.

The account management system includes an account management application, carried internally in the wireless device, that manages a variety of accounts. The account management application interacts with one or more accounting applications, such as, a complex billing algorithm with multiple factor accounting protocol to account for local charges, roaming charges when the wireless device moves from one zone to another, long distance charges, international charges including country independent local charges, and surcharges which may be per call or rate based. The complex billing algorithm can be expanded to accommodate special charges of service providers or called stations or special discounts or premiums for data transfer calls.

The accounting applications related to mobile phone usage may include a rate schedule. A rate schedule in the wireless device may be periodically updated by wireless communications with the service provider's host processor or customer service representative. The accounting applications related to m-commerce transactions obtain the amount to be deducted from a pre-defined communication protocol with the vendor's transaction device or customer service representative.

It is to be understood that the accounting applications may reside either in the wireless device or on a network which is accessible to the wireless device. Depending on design specification or constraints, the functionality of the account management application may be incorporate into the accounting application.

It is to be further understood that the wireless device with the account management system can be implemented into existing wireless communication networks without substantial modification to the network and can be implemented into most existing wireless devices with minimal modification, primarily by internal reprogramming of the wireless device. Modification to most existing wireless devices is even more minimal when existing accounting applications residing on a network are utilized by the wireless device.

A wireless device such as a mobile phone currently includes an internal processor and sufficient internal memory to incorporate the programming and data storage necessary to accomplish the real time accounting. The account management application and the complex algorithms providing the multiple factor accounting capabilities are sufficiently compact that storage and processing of the call data is enabled in real time with sufficient accuracy to account for multiple charges from multiple service providers even for a roaming phone. The accounting and account management applications should utilize an encryption system to permit secure programming and transactions over the airways.

The accounting and account management system as described herein provides customers and businesses with greater flexibility in managing costs of mobile phone use and m-commerce transactions, especially where costs must be segregated into different accounts by multiple criteria such as business versus personal, or by different profit centers within the same business. The increased flexibility also includes different methods for controlling costs with respect to each account such as pre-paid service or post-paid service with usage limits. The present invention describes a system in which an individual wireless device could be utilized in a controlled service mode for certain purposes such as business calls, in a pre-paid service mode for other purposes such as private calls, and have additional secure electronic accounts for other m-commerce transactions.

The system of the present invention is adapted for analog or digital cellular telephones, radiophones in personal communication service networks and other wireless communication systems. The system is also adapted for other wireless devices, such as personal digital assistants, that are used for m-commerce transactions through short-range radio frequency communication protocols or data bearer communication services such as short message service.

Reference to the remaining portions of the specification, including the drawings and claims, will realize other features and advantages of the present invention. Further features and advantages of the present invention, as well as the structure and operation of various embodiments of the present invention, are described in detail below with respect to accompanying drawings, like reference numbers indicate identical or functionally similar elements.

### BRIEF DESCRIPTION OF THE DRAWINGS

FIG. 1 is a simplified schematic diagram illustrating a typical wireless telecommunication arrangement;

FIG. 2 is a simplified schematic diagram illustrating a typical arrangement for sending data bearer messages such as short message service to a wireless device;

FIG. 3 is a simplified schematic diagram illustrating a typical wireless transaction arrangement; and

FIG. 4 is a simplified schematic diagram showing an exemplary embodiment of a wireless device in accordance with the present invention.

### DETAILED DESCRIPTION OF THE INVENTION

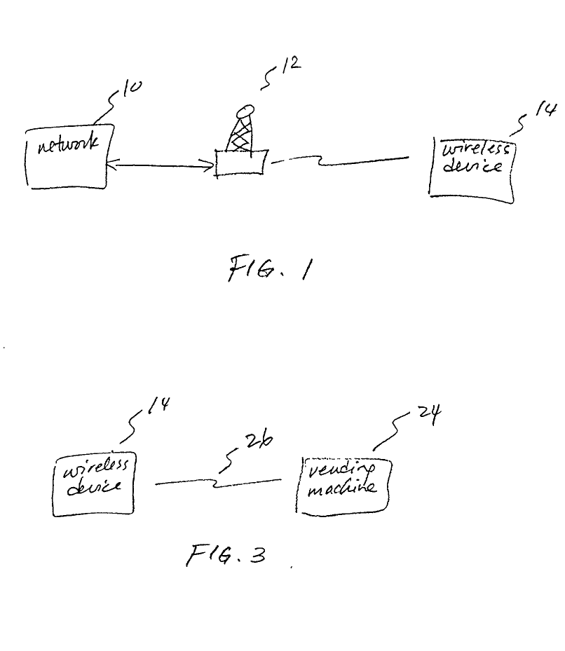

FIG. 1 is a simplified schematic diagram illustrating a typical wireless telecommunication arrangement. A network 10 communicates with a wireless device 14, such as a mobile phone, via a transmission station 12. The transmission station 12 uses over-the-air communications to communicate with the wireless device 14. Over-the-air communication protocols which can be used to implement wireless communications between the wireless device 14 and the network 10 include, for example, GSM, CDMA, TDMA, UMTS, etc. A person of ordinary skill in the art will know of other ways and methods to implement over-the-air communications.

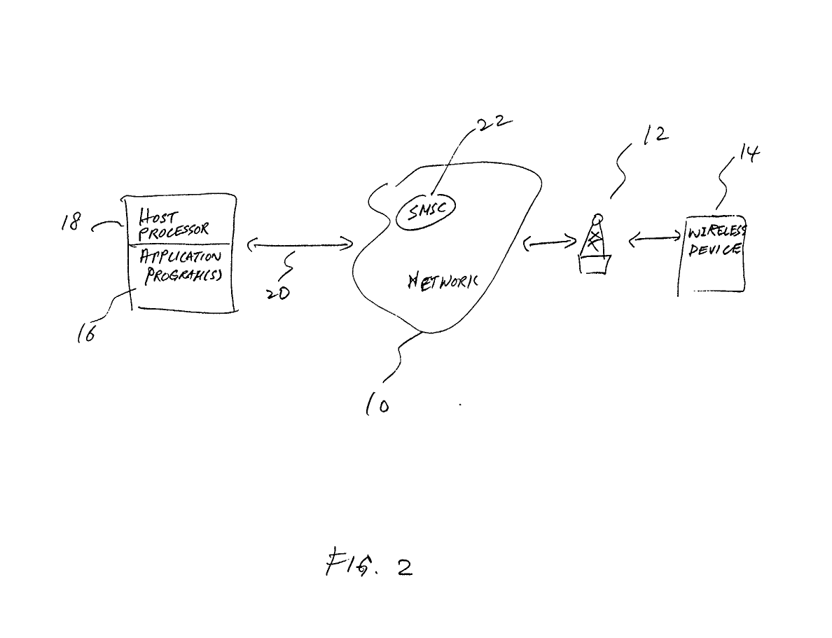

FIG. 2 is a simplified schematic diagram illustrating a typical arrangement for sending data bearer messages such as short message service to a wireless device 14. An application program 16 residing on a host processor 18 uses a communication link 20, such as a TCP/IP link over the Internet, to communicate with a data bearer message controller 22 within the network 10 to transmit a data bearer message such as a short message service message to the wireless device 14, such as a mobile phone, via a transmission station 12.

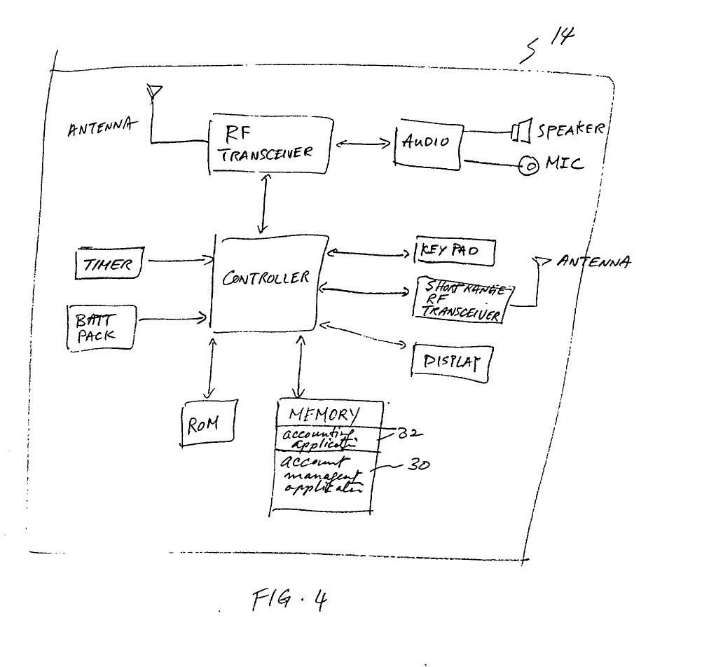

FIG. 3 is a simplified schematic diagram illustrating a typical wireless transaction arrangement. A vending machine 24 with a short range radio communication transceiver and the wireless device 14, such as a mobile phone with a short range radio communication transceiver, communicate using a short range radio communication link 26. Short range radio communication links which can be used to implement wireless communications between the wireless device 14 and the vending machine 24 include, for example, Bluetooth™ wireless communication links. A person of ordinary skill in the art will know of other ways and methods to communicate transactional data between two devices. As another example, vending machine 24 and wireless device 14, each with the appropriate transceiver, can communicate transactional data using a data bearer message service such as short message service.

Referring to FIG. 4, there is shown an exemplary embodiment of the wireless device 14 in accordance with the present invention. According to the exemplary embodiment, the wireless device 14 includes an account management application 30 which permits the usage and account activities of the wireless device 14 to be tracked and monitored on an individual basis. The account management application 30 functions as multiple virtual wallets and is capable of maintaining a number of different accounts which are chargeable for calls or transactions handled by the wireless device 14. The different accounts include, for example, traditional postpaid account, postpaid monitored or controlled usage account, and prepaid account.

The account management application 30 can reside on executable memory within the wireless device 14. Such memory can be one of any type such as ROM, EPROM, or flash memory. The account management application 30 can store dynamic data in RAM and utilize nonvolatile memory such as EEPROM or flash memory to store control data. Alternatively, the account management application 30 can reside on a smart card, such as a universal subscriber identification module (USIM) or Universal Identity Module (UIM), which is attachable to the wireless device 14.

According to an exemplary embodiment, the account management application 30 further interacts with other applications, such as the accounting application 32 described below, so as to properly manage and process the different accounts. The accounting application 32 is capable of calculating calling charges in real time or on the fly. An example of the accounting application 32 is the complex billing algorithm described in the '100 patent. The complex billing algorithm factors the multiple variables of a telephone call from a mobile phone into a billing equation that virtually mirrors the factors considered by public switched network providers and participating wireless service providers, (of which there may be more than one in a single call). The resultant call charge accurately approximates the summation of real charges that will be billed by the participating service providers thereby enabling an instantaneous calculation and display of calling charges. The complex billing algorithm can be expanded to accommodate special charges of service providers or called stations or special discounts or premiums for data transfer calls. The accounting application 32 can reside on executable memory within the wireless device 14. Such memory can be one of any type such as ROM, EPROM, or flash memory. The accounting application 32 can store dynamic data in RAM and utilize nonvolatile memory such as EEPROM or flash memory to store control data. Alternatively, the accounting application 32 can reside on a smart card, such as a universal subscriber identification module (USIM) or Universal Identity Module (UIM), which is attachable to the wireless device 14. In the alternative, it is to be also understood that the accounting application 32 may reside on the network 10. A person of ordinary skill in the art will know of ways and methods to obtain and retrieve calling charge information from an accounting application 32 residing on the network 10.

It is to be further understood that the accounting applications 32 may reside either in the wireless device 14 or on the network 10 which is accessible to the wireless device 14. Depending on design specification or constraints, the functionality of the account management application 30 may be incorporated into or combined with the accounting application 32.

The wireless device 14 can be programmed using systems such as that described in U.S. Pat. No. 6,243,574 B1. In addition to installing account management application 30 and accounting applications 32, programming can include providing data, such as initial monetary values for pre-paid accounts or credit limits, to the wireless device 14. Alternatively, the wireless device 14 can be programmed over the air using DTMF signals, or a data bearer communication service such as short message service, initiated from an application program 16 residing on a host processor 18 such as described in the '100 patent.

The wireless device 14 is preferably a contemporary unit with an LCD display screen for display of numeric or alphanumeric data, such as a user menu and warning messages; a keypad for entry of data, such as menu selections; and a timer for determining the duration of calls thereby allowing calling charges to be calculated. In the alternative, a person of ordinary skill in the art will know that timer information can be obtained from the network 10.

In an exemplary embodiment, the account management application 30 charges a call or transaction to the account selected by a user. The account selection is accomplished via a user interface. The user interface permits the user to interact with the account management application 30 and select which one of the accounts is to be used for each call or transaction. Furthermore, the user interface also allows the user to perform certain account management functions. For example, the user, via the user interface, may transfer balances between accounts or perform other typical accounting functions. As another example, the user, via the user interface, may change the account to which a particular call has been charged. Preferably, the user interface is implemented in the form of a menu of available accounts presented on the LCD screen of the wireless device 14.

In an exemplary mode of operation, the usage and account activities of the wireless device 14 are monitored and tracked as follows. In the situation where an outgoing call is to be made via the wireless device 14, before such call is made, the user using the user interface selects which account is to be charged for that call. Once the account is selected, the user then continues with the normal procedures to make the call. If, for example, a prepaid account is selected, the accounting application 32 then calculates the charges to be debited and the account management application 30 accordingly debits the selected prepaid account.

Similarly, in the situation where an incoming call is to be received by the wireless device 14, before such call is answered, the user using the user interface selects which account is to be charged for that call. Once the account is selected, the user then continues with the normal procedures to receive the call. If, for example, a postpaid account is selected, the charges for the call are calculated and the account management application 30 accordingly updates the postpaid account.

As described above, a selected account is charged for a call handled by the wireless device 14. However, it should be understood that an account may also be charged for any transaction handled by the wireless device 14. That is, the account management application 30 is also able to monitor and track transactions handled by the wireless device 14. For example, referring to FIG. 3, if the wireless device 14 is used to communicate with the vending machine 24 to make a purchase, an appropriate account on the wireless device 14 can similarly be charged for making that purchase.

Alternatively, the account management application 30 may automatically select the account to be charged from a multifactor algorithm. For example, where the wireless device 14 is a multi-line mobile phone, the account management application 30 detects which line of the multi-line mobile phone is in use and charges the account associated with that line. The calling charges to be applied to that account is determined by the accounting application 32. For example, the account management application 30 may select and apply a postpaid account for calls made or received on one line and select and apply a prepaid account for calls made or received on another line.

In another exemplary embodiment, the account management application 30 is able to determine the telephone number of the device which originated the call using the network 10 automatic number identification features, and charge the account associated with that telephone number in a table stored on EEPROM or flash memory within the wireless device 14. In the event that the originating telephone number was not found in the table, a default account is then charged or the user is prompted to select an account to be charged for the call. The timing of the prompt may vary depending on design. For example, the prompt may occur after the call is concluded, if the available prepaid fund and/or credit limit of all potentially chargeable accounts was sufficient. Alternatively, the timing of the prompt may also occur at the preprogrammed time for warning of exhaustion of the available prepaid fund and/or credit limit based on the account, out of all potentially chargeable accounts, which first reaches the time for such warning. It is understood that the multifactor algorithm may include one or more of the above factors, as well as other factors appropriate for selecting the account to be charged.

In an exemplary embodiment, the account management application 30 maintains each account according to an algorithm programmed by the service provider or by authorized corporate personnel. For example, an application program 16 residing on a host processor 18 can provide secure access to authorized corporate personnel to allow such personnel to enter control data with respect to each account. The application program 16 can initiate the transmission of a data bearer message, such as a short message service message, which, when received by the wireless device 14, accordingly reprograms the wireless device 14 with such control data. For example, one account may be set up to be a traditional postpaid account with a limit on usage and a second account may be set up to be a prepaid account. Corporate procedures may require the user to use the first account only for legitimate business calls. The user's compliance with such procedures may be monitored through call detail records stored on the wireless device 14 and transmitted to a host processor as described in the '418 and '669 patents.

It is understood that the call detail records can be stored on RAM or other memory within the wireless device 14, or alternatively, the call detail records can be stored on a smart card, such as a universal subscriber identification module (USIM), which is attachable to the wireless device 14.

The control data transmitted to the wireless device 14 can also be used to determine the consequence of the user reaching a usage limit. For example, one such consequence is for the account management application 30 to generate and transmit an SMS message, or other data bearer message, to the appropriate corporate authority warning that the user had exceeded the usage limit and that review of the call detail records is warranted. Another such consequence is for the account management application 30 to temporarily restrict operation of the wireless device 14, allowing only emergency calls and calls to customer representatives until the restriction is removed. Corporate procedures may permit personal calls on the same wireless device 14 if the user utilizes the second account, the prepaid account. Authorized corporate personnel may receive acceptable forms of payment from the user, and, using the application program 16, transmit control data to the wireless device 14 adding funds to the prepaid account accordingly, similar to the description in the '100 patent.

In another exemplary embodiment, an application program 16 on a host processor 18 is able to provide secure access to authorized personnel of a service provider or, in an intra-corporate system, of the corporation to change control data with respect to each account. The application program 16 can initiate the transmission of a data bearer message, such as a short message service message, which, when received by the wireless device 14, accordingly reprograms the wireless device 14 with such control data. Examples of such changes include changes in the rate tables utilized by the accounting application 32, changes in credit limits for controlled post-paid accounts, and changes in paid finds in pre-paid accounts etc. Alternatively, the users may be provided with over the air access to application program 16 on the host processor 18 to make limited changes, such as using credit cards or prepaid calling cards to add funds to pre-paid accounts, similar to the description provided in the '100 patent. Furthermore, the updated rate table may be transmitted to the wireless device 14 when the user applies for an increase in the internal phone account.

In an exemplary embodiment, the account management application 30 is able to generate audio warnings through the speaker of the wireless device 14 and/or warning messages displayed on the LCD screen of the wireless device 14 so as to inform the user that s/he is about to exhaust the credit limit or prepaid funds. The warning messages may include information identifying the applicable account and the amount of remaining funds or credit.

The system of the present invention provides substantial flexibility by the features described above. For example, a user of the wireless device 14 is given the flexibility to pay for each call differently on an ad hoc basis. A user may wish to separate and pay for the calls based on the nature of each call. Business and personal calls handled by the same wireless device 14 may be paid from different accounts. A business call is to be paid from one account and a personal call is to be paid from another account. A user may also wish to use different accounts to pay for different calls; one call may be paid from a prepaid account, while another call may be charged to a postpaid account.

It is understood that the examples and embodiments described herein are for illustrative purposes only and that various modifications or changes in light thereof will be suggested to persons skilled in the art and are to be included within the spirit and purview of this application and scope of the appended claims. All publications, patents, and patent applications cited herein are hereby incorporated by reference for all purposes in their entirety.

What is claimed is:

1. A system for handling a plurality of account activities, comprising:
a wireless device capable of performing a plurality of billable operations;
an account management application residing in the wireless device;
wherein the account management application is configured to manage a plurality of accounts; and
wherein each billable operation performed by the wireless device is selectively charged to one of the plurality of accounts.

2. The system according to claim 1 further comprising:
a user interface configured to allow a user to determine how each billable operation performed by the wireless device is to be selectively charged to one of the plurality of accounts.

3. The system according to claim 1 wherein the account management application automatically selects one of the plurality of accounts to be charged for at least one of the plurality of billable operations in accordance with an algorithm.

4. The system according to claim 1 further comprising:
an accounting application configured to calculate charges for each billable operation performed by the wireless device;
wherein the account management application functions in cooperation with the accounting application to manage the plurality of accounts.

5. The system according to claim 1 wherein the plurality of billable operations includes making or receiving a voice or data communication.

6. The system according to claim 5 wherein how each billable operation performed by the wireless device is to be selectively charged to one of the plurality of accounts depends on origin or destination of the voice or data communication.

7. The system according to claim 1 wherein the wireless device is a mobile phone.

8. The system according to claim 1 wherein the account management application resides on a smart card attachable to the wireless device.

9. The system according to claim 1 wherein the account management application resides on a memory residing in the wireless device.

10. The system according to claim 1 wherein the accounting application resides on a memory residing in the wireless device.

11. The system according to claim 1 wherein the accounting application resides on a network.

12. The system according to claim 1 wherein the account management application is configured so as to allow a user to transfer balances amongst the plurality of accounts.

13. The system according to claim 1 wherein the plurality of accounts includes a postpaid account and a prepaid account.

14. The system according to claim 1 wherein at least one of the plurality of accounts has a usage limit; and
wherein the plurality of billable operations performable by the wireless device is restricted when the usage limit is exceeded.

15. A wireless device configured to perform a plurality of billable operations, comprising:
an account management application residing on the wireless device and configured to maintain a plurality of accounts;
an accounting application configured to calculate charges for each billable operation performed by the wireless device; and
a user interface configured to allow a user to selectively determine how each billable operation performed by the wireless device is to be charged to one of the plurality of accounts;
wherein the account management application and the accounting application function in cooperation with each other in order to maintain the plurality of accounts.

16. The wireless device of claim 15 wherein the plurality of billable operations includes making or receiving a voice or data communication.

17. The wireless device of claim 16 wherein how each billable operation performed by the wireless device is to be selectively charged to one of the plurality of accounts depends on origin or destination of the voice or data communication.

18. The wireless device of claim 15 wherein the wireless device is a mobile phone.

19. The wireless device of claim 15 wherein the account management application resides on a smart card attached to the wireless device.

20. The wireless device of claim 15 wherein the account management application resides on a memory residing in the wireless device.

21. The wireless device of claim 15 wherein the accounting application resides on a network.

22. The wireless device of claim 15 wherein the account management application is configured so as to allow the user to transfer balances amongst the plurality of accounts.

23. The wireless device of claim 14 wherein the plurality of accounts includes a postpaid account and a prepaid account.

24. The wireless device of claim 14 wherein at least one of the plurality of accounts has a usage limit; and
wherein the plurality of billable operations performable by the wireless device is restricted when the usage limit is exceeded.

25. A mobile phone comprising:
a first line and a second line both configured to make and receive calls; and
an account management application residing on the mobile phone and configured to manage a plurality of accounts;
wherein calls made or received via the first line is charged to one of the plurality of accounts and calls made or received via the second line is charged to another one of the plurality of accounts.

26. The mobile phone of claim 25 further comprising:
a user interface configured to allow a user to selectively determine how each call made or received by the mobile phone is to be charged to one of the plurality of accounts.

27. The mobile phone of claim 25 further comprising:
an accounting application configured to calculate charges for each call made or received by the mobile phone.

28. The mobile phone of claim 25 wherein the account management application resides on a smart card attachable to the mobile phone.

29. The mobile phone of claim 25 wherein the account management application resides on a memory residing in the mobile phone.

30. The mobile phone of claim 27 wherein the accounting application resides on a memory residing in the mobile phone.

31. The mobile phone of claim 27 wherein the accounting application resides on a network.

32. The mobile phone of claim 25 wherein the plurality of accounts includes a postpaid account and a prepaid account.

33. The mobile phone of claim 25 wherein the calls made or received via the first line include business calls and the calls made or received via the second line include personal calls.

34. The mobile phone of claim 25 wherein the account management application is configured so as to allow the user to transfer balances amongst the plurality of accounts.

35. A method for tracking account activities relating to a plurality of billable operations performable by a wireless device, comprising:
selecting one of a plurality of accounts to be charged for a billable operation, wherein the plurality of accounts are maintained on the wireless device;
calculating charges to be paid for the billable operation;
causing the wireless device to perform the billable operation; and
updating the selected account.

36. The method according to claim 35 wherein the step of selecting one of the plurality of accounts further comprises:
allowing a user to select one of the plurality of accounts via a user interface.

37. The method according to claim 35 wherein the step of calculating charges to be paid for the billable operation is performed by an accounting application.

38. The method according to claim 35 wherein the accounting application resides on a memory residing in the wireless device.

39. The method according to claim 35 wherein the accounting application resides on a network.

40. The method according to claim 35 wherein the wireless device is a mobile phone.

41. The method according to claim 35 wherein the billable operation includes making or receiving a voice or data communication.

42. The method according to claim 41 wherein the step of selecting one of a plurality of accounts to be charged for the billable operation further comprises:
identifying origin or destination of the voice or data communication;
selecting the one of the plurality of accounts to be charged for the billable operation based on the identified origin or destination of the voice or data communication.

43. The method according to claim 35 further comprising:
restricting ability of the wireless device to perform the billable operation when credit limit of at least one of the plurality of accounts is exceeded.

44. The method according to claim 35 further comprising:
restricting ability of the wireless device to perform the billable operation when prepaid level of at least one of the plurality of accounts is exhausted or goes below a pre-established limit.

45. A method for tracking account activities made by a mobile phone having a first line and a second line both configured to make and receive calls, comprising:
assigning a first account to calls made or received via the first line;
assigning a second account to calls made or received via the second line, wherein the first and second accounts are maintained on the mobile phone;
making or receiving a call via either the first line or the second line;
calculating charges to be paid for the call; and
updating either the first account or the second account based on the calculated charges depending on which one of the first and second lines the call is made or received.
